(19) United States
(12) Patent Application Publication
(10) Pub. No.: US 2007/0189750 A1
(43) Pub. Date: Aug. 16, 2007

(54) Method of and apparatus for simultaneously capturing and generating multiple blurred images

(75) Inventors: Earl Q. Wong, San Jose, CA (US); Makibi Nakamura, Tokyo (JP); Hidenori Kushida, Tokyo (JP); Soroj Triteyaprasert, Tokyo (JP)

Correspondence Address: Jonathan O. Owens;HAVERSTOCK & OWENS LLP, 162 North Wolfe Road, Sunnyvale, CA, 94086, US

(73) Assignees: Sony Corporation; Sony Electronics Inc.

(21) Appl. No.: 11/357,631

(22) Filed: Feb. 16, 2006

(51) Int. Cl. G03B 13/34

(52) U.S. Cl. 396/121

(57) ABSTRACT

A method to simultaneously generate and capture a plurality of blurred images utilizing a camera lens and a plurality of imaging sensors is described. A signal passes through a lens and is then split into a plurality of signal paths of different lengths using a signal splitting device. Since the physical distances between the lens and the plurality of imaging sensors are different, with different signal path lengths, a plurality of uniquely blurred images are captured by the plurality of imaging sensors. Utilizing the plurality of blurred images, computations are performed and blur differences are calculated. A depth map is then determined from the blur differences. With the depth map, a number of applications are possible.

### FIELD OF THE INVENTION

The present invention relates to the field of imaging. More specifically, the present invention relates to an improved method of imaging by simultaneously capturing and generating multiple blurred images.

### BACKGROUND OF THE INVENTION

A variety of techniques for generating depth maps and autofocusing on objects have been implemented in the past. One method conventionally used in autofocusing devices, such as video cameras, is called a hill-climbing method. The method performs focusing by extracting a high-frequency component from a video signal obtained by an image sensing device such as a CCD and driving a taking lens such that the mountain-like characteristic curve of this high-frequency component is a maximum. In another method of autofocusing, the detected intensity of blur width (the width of an edge portion of the object) of a video signal is extracted by a differentiation circuit.

A wide range of optical distance finding apparatus and processes are known. Such apparatus and processes may be characterized as cameras which record distance information which is often referred to as depth maps of three-dimensional spatial scenes. Some conventional two-dimensional range finding cameras record the brightness of objects illuminated by incident or reflected light. The range finding cameras record images and analyze the brightness of the two-dimensional image to determine its distance from the camera. These cameras and methods have significant drawbacks as they require controlled lighting conditions and high light intensity discrimination.

Another method involves measuring the error in focus, the focal gradient, and employs that measure to estimate the depth. Such a method is disclosed in the paper entitled “A New Sense for Depth Field” by Alex P. Pentland published in the Proceedings of the International Joint Conference on Artificial Intelligence, August, 1985 and revised and republished without substantive change in July 1987 in IEEE Transactions on Pattern Analysis and Machine Intelligence, Volume PAMI-9, No. 4. Pentland discusses a method of depth-map recovery which uses a single image of a scene, containing edges which are step discontinuities in the focused image. This method requires the knowledge of the location of these edges and this method cannot be used if there are no perfect step edges in the scene.

Other methods of determining distance are based on computing the Fourier transforms of two or more recorded images and then computing the ratio of these two Fourier transforms. Computing the two-dimensional Fourier transforms of recorded images is computationally very expensive which involves complex and costly hardware.

U.S. Pat. No. 5,604,537 to Subbarao discloses a method of determining the distance between a surface patch of a 3-D spatial scene and a camera system utilizing one image detector. The distance of the surface patch is determined on the basis of at least a pair of images, each image formed using a camera system with either a finite or infinitesimal change in the value of at least one camera parameter. A first and second image of the 3-D scene are formed using the camera system which is characterized by a first and second set of camera parameters, and a point spread function, respectively, where the first and second set of camera parameters have at least one dissimilar camera parameter value. A first and second subimage are selected from the first and second images so formed, where the subimages correspond to the surface patch of the 3-D scene. The distance from the surface patch to the camera system is to be determined. Based on the first and second subimages, a first constraint is derived between the spread parameters of the point spread function which corresponds to the first and second subimages. From the values of the camera parameters, a second constraint is derived between the spread parameters of the point spread function which corresponds to the first and second subimages. Using the first and second constraints, the spread parameters are then determined. Based on at least one of the spread parameters and the first and second sets of camera parameters, the distance between the camera system and the surface patch in the 3-D scene is determined.

U.S. Pat. No. 5,148,209 to Subbarao discloses apparatus and methods based on signal processing techniques for determining the distance of an object from a camera, rapid autofocusing of a camera, and obtaining focused pictures from blurred pictures produced by a camera. The apparatus includes a camera which utilizes one image detector and is characterized by a set of four camera parameters: position of the image detector or film inside the camera, focal length of the optical system in the camera, the size of the aperture of the camera, and the characteristics of the light filter in the camera. In the method, at least two images of the object are recorded with different values for the set of camera parameters. The two images are converted to a standard format to obtain two normalized images. The values of the camera parameters and the normalized images are substituted into an equation obtained by equating two expressions for the focused image of the object. The two expressions for the focused image are based on a new deconvolution formula which requires computing only the derivatives of the normalized images and a set of weight parameters dependent on the camera parameters and the point spread function of the camera. In particular, the deconvolution formula does not involve any Fourier transforms. The equation which results from equating two expressions for the focused image of the object is solved to obtain a set of solutions for the distance of the object. A third image of the object is then recorded with new values for the set of camera parameters. The solution for distance which is consistent with the third image and the new values for the camera parameters is determined to obtain the distance of the object. Based on the distance of the object, a set of values is determined for the camera parameters for focusing the object. The camera parameters are then set equal to these values to accomplish autofocusing. After determining the distance of the object, the focused image of the object is obtained using the deconvolution formula. A generalized version of the method of determining the distance of an object can be used to determine one or more unknown camera parameters. This generalized version is also applicable to any linear shift-invariant system for system parameter estimation and signal restoration.

U.S. Pat. No. 5,365,597 to Holeva discloses a method and apparatus for passive autoranging. Two cameras having different image parameters (e.g., focal gradients) generate two images of the same scene. A relaxation procedure is performed using the two images as inputs to generate a blur spread. The blur spread may then be used to calculate the range of at least one object in the scene. A temporal relaxation procedure is employed to focus a third camera. A spatial relaxation procedure is employed to determine the range of a plurality of objects.

Other methods have been implemented by comparing multiple images to determine a depth. One method includes using an image that is in-focus and an image that is out-of-focus where the in-focus value is zero, hence the mathematics are very simple. Another method utilizes two separate images, with different focuses, where the distance is the difference between the images is the blur of the first image minus the blur of the second image. However, the method of obtaining the two images has been to take two separate pictures with a camera at different distances. The distances are varied by moving the lens while keeping the sensor stationary or moving the sensor while keeping the lens in place. Either way, there are a number of drawbacks with such an approach. The biggest issue involves artifacts which are created if something in the scene moves. Additional calculations must be made to correct for such motion.

### SUMMARY OF THE INVENTION

A method to simultaneously generate and capture a plurality of blurred images utilizing a camera lens and a plurality of imaging sensors is described. A signal passes through a lens and is then split into a plurality of signal paths of different lengths using a signal splitting device. Since the physical distances between the lens and the plurality of imaging sensors are different, with different signal path lengths, a plurality of uniquely blurred images are captured by the plurality of imaging sensors. Utilizing the plurality of blurred images, computations are performed and blur differences are calculated. A depth map is then determined from the blur differences. With the depth map, a number of applications are possible.

In one aspect, a system for generating a depth map comprises a lens for obtaining a signal, a splitter for splitting the signal into a plurality of signals and a plurality of sensors for receiving the plurality of signals, wherein the plurality of sensors are each a different distance from the splitter. The lens, the splitter and the plurality of sensors are contained within an imaging device. The imaging device is selected from the group consisting of a camera, a video camera, a camcorder, a digital camera, a cell phone and a PDA. The signal comprises a blurred image. The signal comprises a section of a blurred image. The depth map is utilized to autofocus the lens. The plurality of signals are generated simultaneously. The depth map is utilized to assist in a task selected from the group consisting of photography, surveillance, computer/robot vision and autonomous vehicle navigation.

In another aspect, a system for autofocusing comprises a lens for obtaining a signal, a splitter for splitting the signal into a first split signal and a second split signal, a first sensor for receiving the first split signal, wherein the first sensor is a first distance from the splitter, a second sensor for receiving the second split signal, wherein the second sensor is a second distance from the splitter, further wherein the second distance is different from the first distance and a depth map generated from the plurality of signals received by the plurality of sensors, wherein the focus of the lens is automatically modified utilizing the depth map. The lens, the splitter, the first sensor, the second sensor and the depth map are contained within an imaging device. The imaging device is selected from the group consisting of a camera, a video camera, a camcorder, a digital camera, a cell phone and a PDA. The signal comprises a blurred image. The signal comprises a section of a blurred image. The first split signal and the second split signal are generated simultaneously. The depth map is utilized to assist in a task selected from the group consisting of photography, surveillance, computer/robot vision and autonomous vehicle navigation.

In yet another aspect, a system for autofocusing an imaging device comprises a lens for obtaining a signal, a splitter for simultaneously splitting the signal into a plurality of signals wherein the plurality of signals are of a blurred image, a plurality of sensors for receiving the plurality of signals, wherein the plurality of sensors are each a different distance from the splitter and a depth map generated from the plurality of signals received by the plurality of sensors, wherein the focus of the lens is automatically modified utilizing the depth map. The imaging device is selected from the group consisting of a camera, a video camera, a camcorder, a digital camera, a cell phone and a PDA. The depth map is utilized to assist in a task selected from the group consisting of photography, surveillance, computer/robot vision and autonomous vehicle navigation.

In another embodiment, a method for generating a depth map within an imaging device comprises obtaining a signal, splitting the signal with a splitter into a plurality of signals, receiving the plurality of signals at a plurality of sensors, wherein the plurality of sensors are each at a different distance from the splitter and determining the depth map based on a set of calculations utilizing the plurality of sensors. The imaging device is selected from the group consisting of a camera, a video camera, a camcorder, a digital camera, a cell phone and a PDA. The signal comprises a blurred image. The signal comprises a section of a blurred image. The depth map is utilized to assist in a task selected from the group consisting of photography, surveillance, computer/robot vision and autonomous vehicle navigation. The plurality of signals are generated simultaneously. The method further comprises autofocusing utilizing the depth map. The method further comprises partitioning the plurality of signals into a plurality of sections. The method further comprises computing a blur quantity difference from the plurality of sections.

In yet another embodiment, a method of autofocusing by simultaneously generating and capturing a plurality of blurred images comprises capturing a signal with an imaging device, splitting the signal with a splitter into a first split signal and a second split signal, receiving the first split signal at a first sensor and the second split signal at a second sensor, wherein the first sensor and the second sensor are at different distances from the splitter, partitioning the first split signal into a first plurality of sections, partitioning the second split signal into a second plurality of sections, computing a blur quantity difference from the first plurality of sections and the second plurality of sections, determining a depth map based on calculations utilizing the blur quantity difference and autofocusing on a scene utilizing the depth map. The imaging device is selected from the group consisting of a camera, a video camera, a camcorder, a digital camera, a cell phone and a PDA.

### BRIEF DESCRIPTION OF THE DRAWINGS

FIG. 1 illustrates a graphical representation of an exemplary system for capturing a plurality of different blurred images.

FIG. 2 illustrates a perspective view of an exemplary implementation of the system for capturing a plurality of different blurred images.

FIG. 3 illustrates a flowchart of autofocusing utilizing a plurality of blurred images.

### DETAILED DESCRIPTION OF THE PREFERRED EMBODIMENT

A method to simultaneously generate and capture N blurred images utilizing a camera lens and N imaging sensors is described. A signal passes through a lens and is then split into N signal paths of different lengths using a signal splitting device. Since the physical distances between the lens and the N imaging sensors are different, with different signal path lengths, N uniquely blurred images are captured by the N imaging sensors. Utilizing the N blurred images, computations are performed and blur differences are calculated. A depth map is then determined from the blur differences. With the depth map, a number of applications are possible.

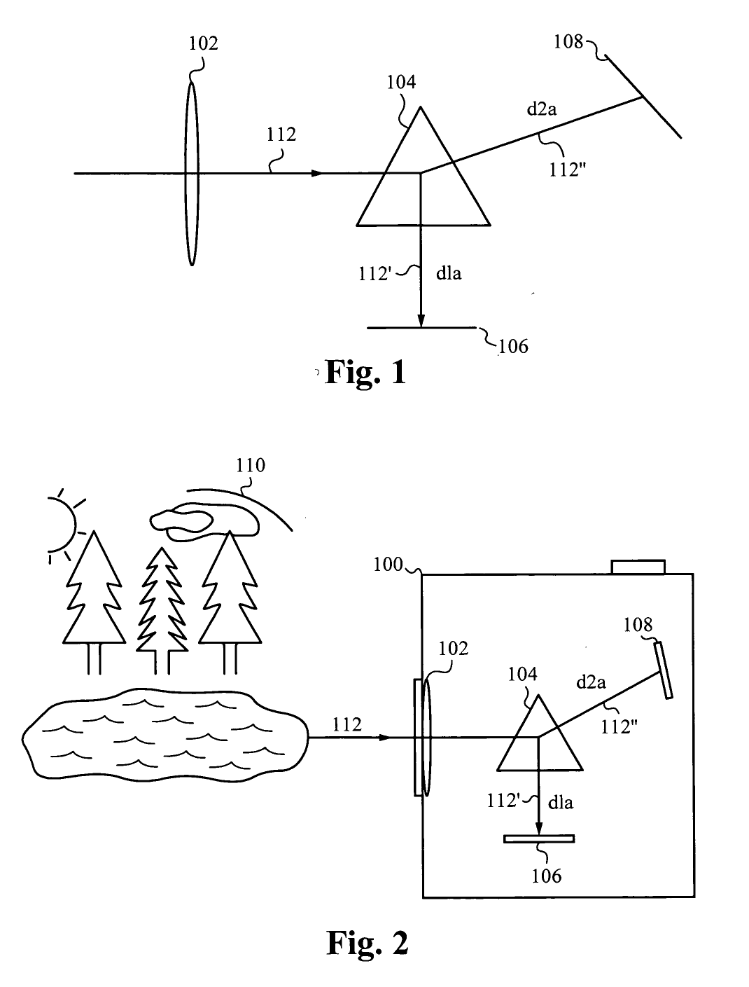

FIG. 1 illustrates a graphical representation of an exemplary system for capturing a plurality of different blurred images. A signal 112 of the image passes through a lens 102 and is then split by a splitter 104 into signals 112′ and 112″. The two signals 112′ and 112″ travel in different directions and for different distances, where distance, d1a, corresponds with signal 112′ and distance, d2a, corresponds with signal 112″. Two different image sensors, image sensor 106 and image sensor 108, receive the split signals 112′ and 112″. Specifically, the image sensor 106 receives the image signal 112′ and the image sensor 108 receives the image signal 112″. Since the distance from the splitter 104 and the image sensor 106 is different than the distance from the splitter 104 and the image sensor 108, the image signals are sensed with different blur quantities. For example, the image that arrives at the image sensor 106 is X percent out-of-focus and the image that arrives at the image sensor 108 is Y percent out-of-focus, thus their respective blur amounts are different. The image signals 112′ and 112″ are partitioned into a plurality of sections which are then used in computations to determine the difference between the blur quantities. Utilizing the difference in blur, a depth map is generated so that the distance of the objects in a scene are able to be determined. With a depth map, any number of features are able to be implemented, such as autofocus. Within other embodiments, the signal is able to be split into N different directions to N different sensors, where (N≧2).

FIG. 2 illustrates a perspective view of an exemplary implementation of the system for capturing a plurality of different blurred images. The imaging device 100 is utilized to capture an image from a scene 110 as would any typical imaging device. The imaging device 100 includes, but is not limited to cameras, video cameras, camcorders, digital cameras, cell phones, and PDAs. The signal 112 of the image passes through the lens 102 and is then split by the splitter 104 into the signals 112′ and 112″. The two signals 112′ and 112″ travel in different directions and for different distances, where distance, d1a, corresponds with signal 112′ and distance, d2a, corresponds with signal 112″. The image sensor 106 receives the image signal 112′ and the image sensor 108 receives the image signal 112″. Since the distance from the splitter 104 and the image sensor 106 is different than the distance from the splitter 104 and the image sensor 108, the image signals are sensed with different blur quantities. The image signals 112′ and 112″ are partitioned into a plurality of sections which are then used in computations to determine the difference between the blur quantities. Utilizing the difference in blur, a depth map is generated so that the distance of the objects in a scene are able to be determined. The imaging device 100 is then able to autofocus on a desired object within the scene utilizing the generated depth map. Within other embodiments, the signal is able to be split into N different directions to N different sensors, where (N≧2). Through the use of more sensors, more blur differences are able to be calculated to further ensure generation of an accurate depth map.

As described above, only one image needs to be acquired for the blur comparison because the image signal is split and directed to the plurality of different image sensors. In some embodiments, that image is then partitioned and analyzed. In other embodiments, a portion of an image is captured, since all of the data of the image is not required. A section of an image with enough data is used so that the blur quantities are able to be compared. For example, the top right portion of the scene in FIG. 2 is acquired. After the image section signal is split, the two sensors compare the blur quantities of the section without the need of the rest of the scene. With a depth map determined for the acquired section, the image device is able to autofocus on the entire scene based on that one section.

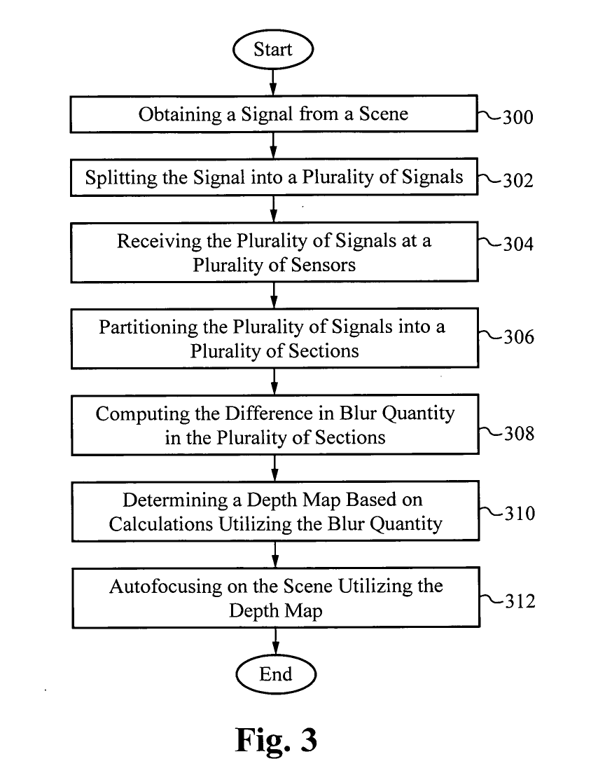

FIG. 3 illustrates a flowchart of autofocusing utilizing a plurality of blurred images. In the step 300, a signal of an image is obtained from a scene utilizing an imaging device. In the step 302, the signal is split into a plurality of signals by a splitter. In the step 304, the plurality of signals are received/captured at a plurality of sensors, where each of the sensors are positioned at a different distance from the splitter. Since the distance between each sensor and the splitter is different, each sensor receives an image with a different blur quantity. After the plurality of signals are captured on the plurality of sensors, they are partitioned into a plurality of smaller sections, in the step 306. Then, the difference in blur quantity for each set of sections is computed in the step 308 (e.g. the upper left of image one is compared with the upper left of image two). Once the difference in blur quantity is known, it is applied to a mathematical relation which determines the depth map, in the step 310. In the step 312, the imaging device utilizes the depth map to autofocus on the desired section of the scene. In other embodiments, other devices are able to utilize the method described above including, but not limited to, surveillance systems, computers/robots, autonomous vehicle navigation systems and any other system that would benefit from an improved ability to determine depth.

As described above, N imaging sensors (N≧2) inside an imaging device are utilized to simultaneously capture N uniquely blurred pictures (N≧2). The imaging sensors are placed at different distances from the lens which is fixed at a specific location. Different physical distances correspond to different path lengths. The signal is split using a signal splitter and diverted to the N different imaging sensors. Since the distances are different between the splitter and the N different imaging sensors, two or more uniquely blurred images are generated and captured which are then used to generate a depth map.

There are a number of devices that are able to utilize the method of capturing and generating multiple blurred images to generate a depth map. Such a device obtains a signal of an image from a scene. The signal passes through a lens and then is split by a splitter into a plurality of signals. A plurality of sensors receive the plurality of signals. Each signal is directed to a specific sensor for receiving the signal, and the sensors are distanced from the splitter so that the sensors have different distances. With different distances, the signals of the images arrive at the sensors with differing blur quantities. The blur quantity difference is able to be calculated and then used to determine the depth map. With the depth map, many applications are possible such as autofocusing, surveillance, robot/computer vision and autonomous vehicle navigation. For a user of the device which implements the method described above, the functionality is similar to that of other similar technologies. For example, a person who is taking a picture with a camera which utilizes the method to capture and generate multiple blurred images, uses the camera as a generic autofocusing camera. The camera generates a depth map, and then automatically focuses the lens until it establishes the proper focus for the picture, so that the user is able to take a clear picture. However, as described above, the method and system described herein have significant advantages over other autofocusing devices.

In operation, the method and system for capturing and generating multiple blurred images to determine a depth map improve a device's ability to perform a number of functions such as autofocusing. As described above, when a user is utilizing a device which implements the method and system described herein, the device functions as a typical device would. The improvements of being able to compute a depth map without implementing Fourier transforms or other computationally expensive algorithms enable autofocusing utilizing a plurality of blurred images captured on a plurality of sensors. Furthermore, by splitting the signal into a plurality of signals within the device, where the plurality of signals are received by a plurality of sensors at differing distances, the concerns of using multiple images, which could have movement and therefore artifacts, are alleviated. Unlike previous devices, the invention described herein is able to obtain a plurality of blurred images from one signal by splitting the signal. The plurality of blurred images obtained on a plurality of sensors are utilized to generate a depth map to be utilized in applications which require determining the depth of objects within a scene.

Additionally, the method is able to be utilized to generate a depth map for autofocus using an all-in-focus picture. Furthermore, the method is able to be utilized to generate depth information for autofocus using multiple pictures and 2D Gaussian Scale Space.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A system for generating a depth map comprising:
a. a lens for obtaining a signal;
b. a splitter for splitting the signal into a plurality of signals; and
c. a plurality of sensors for receiving the plurality of signals, wherein the plurality of sensors are each a different distance from the splitter.

2. The system as claimed in claim 1 wherein the lens, the splitter and the plurality of sensors are contained within an imaging device.

3. The system as claimed in claim 2 wherein the imaging device is selected from the group consisting of a camera, a video camera, a camcorder, a digital camera, a cell phone and a PDA.

4. The system as claimed in claim 1 wherein the signal comprises a blurred image.

5. The system as claimed in claim 1 wherein the signal comprises a section of a blurred image.

6. The system as claimed in claim 1 wherein the depth map is utilized to autofocus the lens.

7. The system as claimed in claim 1 wherein the plurality of signals are generated simultaneously.

8. The system as claimed in claim 1 wherein the depth map is utilized to assist in a task selected from the group consisting of photography, surveillance, computer/robot vision and autonomous vehicle navigation.

9. A system for autofocusing comprising:
a. a lens for obtaining a signal;
b. a splitter for splitting the signal into a first split signal and a second split signal;
c. a first sensor for receiving the first split signal, wherein the first sensor is a first distance from the splitter;
d. a second sensor for receiving the second split signal, wherein the second sensor is a second distance from the splitter, further wherein the second distance is different than the first distance; and
e. a depth map generated from the plurality of signals received by the plurality of sensors;
wherein a focus of the lens is automatically modified utilizing the depth map.

10. The system as claimed in claim 9 wherein the lens, the splitter, the first sensor, the second sensor and the depth map are contained within an imaging device.

11. The system as claimed in claim 10 wherein the imaging device is selected from the group consisting of a camera, a video camera, a camcorder, a digital camera, a cell phone and a PDA.

12. The system as claimed in claim 9 wherein the signal comprises a blurred image.

13. The system as claimed in claim 9 wherein the signal comprises a section of a blurred image.

14. The system as claimed in claim 9 wherein the first split signal and the second split signal are generated simultaneously.

15. The system as claimed in claim 9 wherein the depth map is utilized to assist in a task selected from the group consisting of photography, surveillance, computer/robot vision and autonomous vehicle navigation.

16. A system for autofocusing an imaging device comprising:
a. a lens for obtaining a signal;
b. a splitter for simultaneously splitting the signal into a plurality of signals wherein the plurality of signals are of a blurred image;
c. a plurality of sensors for receiving the plurality of signals, wherein the plurality of sensors are each a different distance from the splitter; and
d. a depth map generated from the plurality of signals received by the plurality of sensors;
wherein the focus of the lens is automatically modified utilizing the depth map.

17. The system as claimed in claim 16 wherein the imaging device is selected from the group consisting of a camera, a video camera, a camcorder, a digital camera, a cell phone and a PDA.

18. The system as claimed in claim 16 wherein the depth map is utilized to assist in a task selected from the group consisting of photography, surveillance, computer/robot vision and autonomous vehicle navigation.

19. A method for generating a depth map within an imaging device comprising:
a. obtaining a signal;
b. splitting the signal with a splitter into a plurality of signals;
c. receiving the plurality of signals at a plurality of sensors, wherein the plurality of sensors are each at a different distance from the splitter; and
d. determining the depth map based on a set of calculations utilizing the plurality of sensors.

20. The method as claimed in claim 19 wherein the imaging device is selected from the group consisting of a camera, a video camera, a camcorder, a digital camera, a cell phone and a PDA.

21. The method as claimed in claim 19 wherein the signal comprises a blurred image.

22. The method as claimed in claim 19 wherein the signal comprises a section of a blurred image.

23. The method as claimed in claim 19 wherein the depth map is utilized to assist in a task selected from the group consisting of photography, surveillance, computer/robot vision and autonomous vehicle navigation.

24. The method as claimed in claim 19 wherein the plurality of signals are generated simultaneously.

25. The method as claimed in claim 19 further comprising autofocusing utilizing the depth map.

26. The method as claimed in claim 19 further comprising partitioning the plurality of signals into a plurality of sections.

27. The method as claimed in claim 26 further comprising computing a blur quantity difference from the plurality of sections.

28. A method of autofocusing by simultaneously generating and capturing a plurality of blurred images comprising:
a. capturing a signal with an imaging device;
b. splitting the signal with a splitter into a first split signal and a second split signal;
c. receiving the first split signal at a first sensor and the second split signal at a second sensor, wherein the first sensor and the second sensor are at different distances from the splitter;
d. partitioning the first split signal into a first plurality of sections;
e. partitioning the second split signal into a second plurality of sections;
f. computing a blur quantity difference from the first plurality of sections and the second plurality of sections;
g. determining a depth map based on calculations utilizing the blur quantity difference; and
h. autofocusing on a scene utilizing the depth map.

29. The method as claimed in claim 28 wherein the imaging device is selected from the group consisting of a camera, a video camera, a camcorder, a digital camera, a cell phone and a PDA.
